(19) United States
(12) Patent Application Publication
(10) Pub. No.: US 2025/0087764 A1
(43) Pub. Date: Mar. 13, 2025

(54) CONFIGURATION METHOD FOR A PLURALITY OF SERIAL CODES OF A BATTERY MANAGEMENT SYSTEM

(71) Applicant: MOBILETRON ELECTRONICS CO., LTD., Taichung City (TW)

(72) Inventors: PIN-HAO WANG, Taichung City (TW); WEN-CHUAN HUNG, Taichung City (TW)

(73) Assignee: MOBILETRON ELECTRONICS CO., LTD., Taichung City (TW)

(21) Appl. No.: 18/829,221

(22) Filed: Sep. 9, 2024

(30) Foreign Application Priority Data
Sep. 12, 2023 (TW) 112134674

(51) Int. Cl. H01M 10/42

(52) U.S. Cl. CPC H01M 10/425; H01M 10/4207; H01M 2010/4271; H01M 2010/4278

(57) ABSTRACT

A configuration method for a plurality of serial codes of a battery management system, wherein the battery management system includes a master battery management device and a plurality of slave battery management devices. The configuration method comprises steps of: sending, by each slave battery management device, a notification message through a first communication interface, wherein each notification message includes an identification code of each slave battery management device; receiving, by the master battery management device, each notification message and acquiring each identification code from each notification message received; counting, by the master battery management device, a number of the identification codes and performing a configuration step when the number of the identification codes is determined to be equal to a predetermined number of connections. In the configuration step, the first to the last of the slave battery management devices are configured sequentially with a serial code.

### BACKGROUND OF THE INVENTION

### Technical Field

The present invention relates generally to a power storage system having battery packs, and more particularly to a configuration method for a plurality of serial codes of a battery management system, especially for a power storage system.

### Description of Related Art

A conventional power storage system includes a plurality of battery packs connected in series, parallel, or series-parallel to supply power to a load. Each battery pack has a battery management device, also known as a battery management unit (BMU) or a cell monitor unit (CMT), which is configured to detect a state of each battery pack, such as a voltage, a current, a temperature, etc. The battery management device encodes the state of the battery pack together with a specified serial number into a state message to be sent out through a communication bus, and the serial number is used by a device (e.g., a control computer) receiving the state message to identify which battery pack's battery management device is sending the state message. The aforementioned serial number is burned into a non-volatile memory of the battery management device as the battery pack is manufactured. Hence, a corresponding recording apparatus is required to alter the serial number stored in the non-volatile memory when the serial number of the battery pack needs to be altered subsequently, resulting in inconvenience in altering the serial number.

To improve the disadvantages above, an existing battery pack further includes an encoding switch connected to the battery management device for a user to set the serial number of the battery management device by operating the encoding switch, thereby facilitating altering the serial number. However, when operating the encoding switch, the user is required to keep the eyes on numerical markings on the encoding switch to set a corresponding serial number, which is easy for the user to misread the numerical markings. When the encoding switch is set incorrectly, the battery management device could send an incorrect state message out, and there could be instances where the serial numbers of two battery management devices are duplicated.

Therefore, the conventional method for setting the serial numbers still has room for improvement.

### BRIEF SUMMARY OF THE INVENTION

In view of the above, the primary objective of the present invention is to provide a configuration method for a plurality of serial codes of a battery management system to assign the serial codes automatically, and the serial codes assigned are the serial codes of the battery pack.

The present invention provides a configuration method for a plurality of serial codes of a battery management system, wherein the battery management system includes a master battery management device and a plurality of slave battery management devices. The master battery management device is connected to the plurality of slave battery management devices through a first communication interface, and a first to a last of the plurality of slave battery management devices are connected in sequence. The first of the plurality of slave battery management devices is connected to the master battery management device through a second communication interface, and each of the two slave battery management devices connected to each other is connected through an another second communication interface. The configuration method comprises steps of:
A. sending, by each slave battery management device, a notification message to the master battery management device through the first communication interface, wherein each notification message includes an identification code of each slave battery management device and the plurality of identification codes of the plurality of the slave management devices are different from each other;
B. receiving, by the master battery management device, each notification message sent by each slave battery management device and acquiring, by the master battery management device, the identification code of each slave battery management device from each notification message received;
C. counting, by the master battery management device, a number of the plurality of identification codes; performing, by the master battery management device and the plurality of slave battery management devices, a configuration step when the master battery management device determines that the number of the plurality of identification codes is equal to a predetermined number of connections;
wherein the configuration step includes:
D1. sending, by the master battery management device, a first setup command to the first of the plurality of slave battery management devices through the second communication interface, thereby causing the first of the plurality of slave battery management devices to be configured with one of the plurality of serial codes;
D2. sending sequentially, by each of the first to a penultimate of the plurality of slave battery management devices, a second setup command to a next slave battery management device connected in sequence through the corresponding another second communication interface after each of the first to the penultimate of the plurality of slave battery management devices has been configured with each serial code in sequence, thereby causing the next slave battery management device connected in sequence to be configured with one of the following serial codes until the last of the plurality of slave battery management devices has been configured with a last of the plurality of serial codes.

With the aforementioned design, the configuration step is only allowed to be performed when the master management device determines that the number of the slave battery management devices is the same as the predetermined number of connections, preventing the number of the slave battery management devices from being incorrect. With the configuration step, the serial codes could be assigned automatically to the slave battery management devices in sequence, effectively improving the problem that the user could easily make mistakes in setting the serial codes through a switch.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the power storage system according to an embodiment of the present invention;

FIG. 2 is a schematic view of the battery management system according to the embodiment of the present invention;

FIG. 3 is a flow chart of the configuration method for the serial codes according to the embodiment of the present invention; and

FIG. 4 is a flow chart of the configuration step according to the embodiment of the present invention.

### DETAILED DESCRIPTION OF THE INVENTION

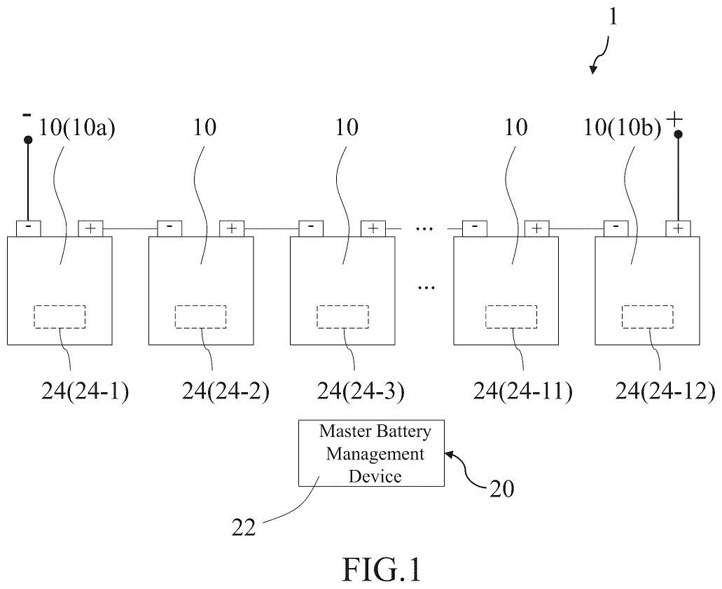

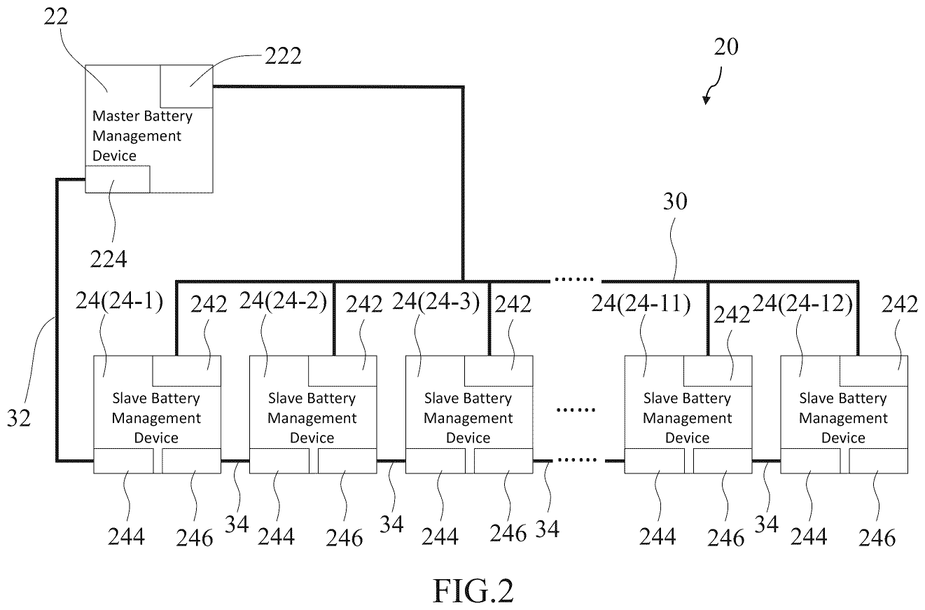

A power storage system 1 that a configuration method for a plurality of serial codes of a battery management system 20 according to an embodiment of the present invention is applied to is illustrated in FIG. 1 and FIG. 2, wherein the power storage system 1 is configured to supply power to a load (not shown), which could be, for example, a vehicle (truck, ship, aircraft, etc.), or a power grid. The power storage system 1 could also be applied to an energy storage system. The power storage system 1 includes a plurality of battery packs 10 and the battery management system 20.

The plurality of battery packs 10 are connected in series as an example, and a negative terminal of a first battery pack 10a and a positive terminal of a last battery pack 10b are electrically connected to a power distribution unit (PDU) of the load, but it is not limited thereto; the positive terminal and the negative terminal of each battery pack 10 could interchange positions mutually, and the positive terminal of the first battery pack 10a and the negative terminal of the last battery pack 10b are electrically connected to a power distribution unit of the load. In addition, the plurality of battery packs 10 could also be connected in parallel or in series-parallel, which is not limited to being connected in series. In the current embodiment, a number of the battery packs 10 includes twelve battery packs as an example, but it is not limited thereto.

The battery management system 20 includes a master battery management device 22 and a plurality of slave battery management devices 24. The master battery management device 22 includes a first transmission module 222 and a second transmission module 224, in which the first transmission module 222 is configured to be connected to a first communication interface 30. In the current embodiment, the first transmission module 222 is a CAN-bus transmission module as an example, but it is not limited thereto. The first communication interface 30 is a CAN-BUS as an example, but is not limited thereto; the first communication interface 30 could also be an interface, such as USB, local interconnect network bus (LIN BUS), Ethernet, etc., which could be used for communication between multiple devices. The first communication interface 30 could be connected to a control device to communicate with the control device. For example, when the power storage system 1 is applied to vehicles, the control device could be a vehicle control unit (VCU) or a control computer; when the power storage system 1 is applied to the energy storage system, the control device could be an energy management system (EMS). The second transmission module 224 is configured to be connected to a second communication interface 32. In the current embodiment, the second transmission module 224 is a serial transmission module as an example, and the second communication interface 32 is a serial communication interface as an example, such as an RS-485 communication interface, but it is not limited thereto; the second communication interface 32 could also be RS-232, RS-422, UART, USB, CAN bus, LIN BUS, Ethernet, etc.

In the current embodiment, a number of the slave battery management devices 24 includes twelve slave battery management devices as an example, but it is not limited thereto. Each slave battery management device is disposed in each battery pack 10 and is configured to detect a state of each battery pack 10, such as at least one of a voltage, a current, and a temperature. Each slave battery management device 24 includes a first transmission module 242, a second transmission module 244, and a third transmission module 246. The first transmission module 242 of each slave battery management device 24 is a CAN-bus transmission module as an example, but it is not limited thereto. The first transmission modules 242 of the plurality of slave battery management devices 24 are electrically connected to the first communication interface 30, such that the master battery management 22 is connected to the plurality of slave battery management devices 24 through the first communication interface 30. The second transmission module 244 and the third transmission module 246 of each slave battery management device 24 is a serial transmission module as an example, but it is not limited thereto.

As shown in FIG. 2, a first (a slave battery management device 24-1) to a last (a slave battery management device 24-12) of the plurality of slave battery management devices are connected in sequence. In the current embodiment, the plurality of slave battery management devices are connected in series. The slave battery management devices 24-2 to 24-11 are connected in sequence between the slave battery management device 24-1 and the slave battery management device 24-12.

More specifically, the second transmission module 244 of the first (the slave battery management device 24-1) of the plurality of slave battery management devices is electrically connected to the second communication interface 32, such that the first (the slave battery management device 24-1) of the plurality of slave battery management devices could be connected to the master battery management device 22 through the second communication interface 32. Each of the two slave battery management devices connected to each other is connected through another second communication interface 34; that is, the third transmission module 246 of each slave battery management device 24 and the second transmission module 244 of a next slave battery management device 24 is electrically connected to one communication interface 34. In the current embodiment, the second communication interface 34 is a serial communication interface as an example, such as an RS-485 communication interface, but it is not limited thereto; the second communication interface 34 could also be RS-232, RS-422, UART, USB, CAN bus, LIN BUS, Ethernet, etc. Each second communication interface 34 is the same as the second communication interface 32. The third transmission module 246 of the last slave battery management device 24-12 is not connected to the second communication interface 34; alternatively, the last slave battery management device 24-12 could not be provided with the third transmission module 246. In this way, each slave battery management device 24 could communicate with another slave battery management device 24 connected thereto through a corresponding second communication interface 34.

Each slave battery management device 24 records an identification code that could be recorded in a memory of each slave battery management device 24. Each identification code represents a unique identification code for each slave battery management device 24 and/or a unique identification code for each battery pack 10. The identification codes could be non-consecutive and non-repeating; for example, the identification code could be a manufacturing code of each slave battery management device 24 and/or each battery pack 10. However, the identification codes are not limited thereto as long as the identification codes of the slave battery management devices 24 are different.

With the aforementioned structure, the configuration method for the plurality of serial codes of the battery management system 20 according to the current embodiment could be performed. The configuration method is for assigning each serial code to each slave battery management device 24, and each serial code assigned is the serial code of each battery pack 10 in the energy storage system 1, such that the master battery management device 22 could identify each slave battery management device 24 or each battery pack 10 by each serial code. Each serial code could include one or a combination of numbers, letters, symbols, characters, etc. For example, the serial codes could be in the form of sequences of numbers; a value of each serial code could be in binary system, decimal system, hexadecimal system, or any other number systems, and the values of the serial codes are incremented or decremented. Alternatively, the serial codes could be sequences of multiple letters. Taking twelve letters, A to L, as an example, a sequence of the letters in the serial code could be ascending (such as A to L) or descending (such as L to A), in which the sequence could be, for example, ascending or descending according to the value of ASCII codes of the letters. Additionally, serial numbers could also be one of the forms of the serial codes according to the present invention.

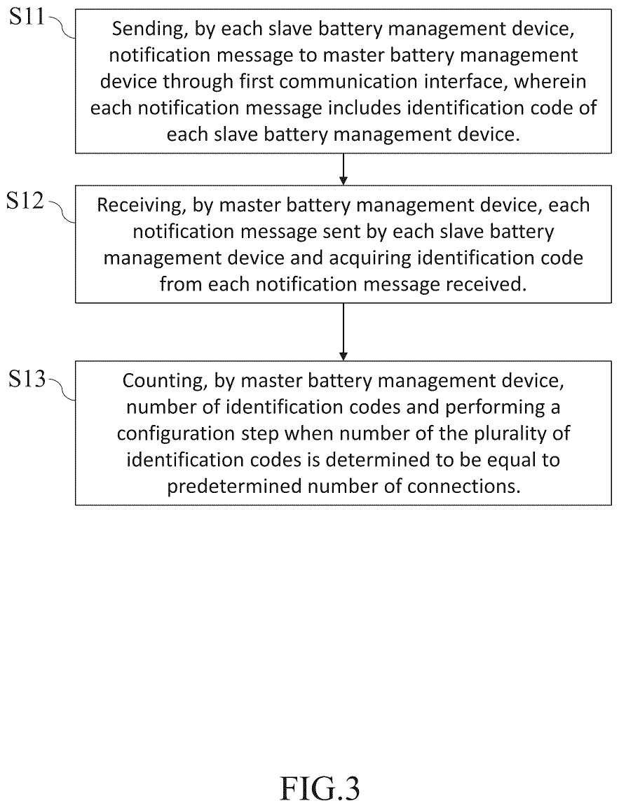

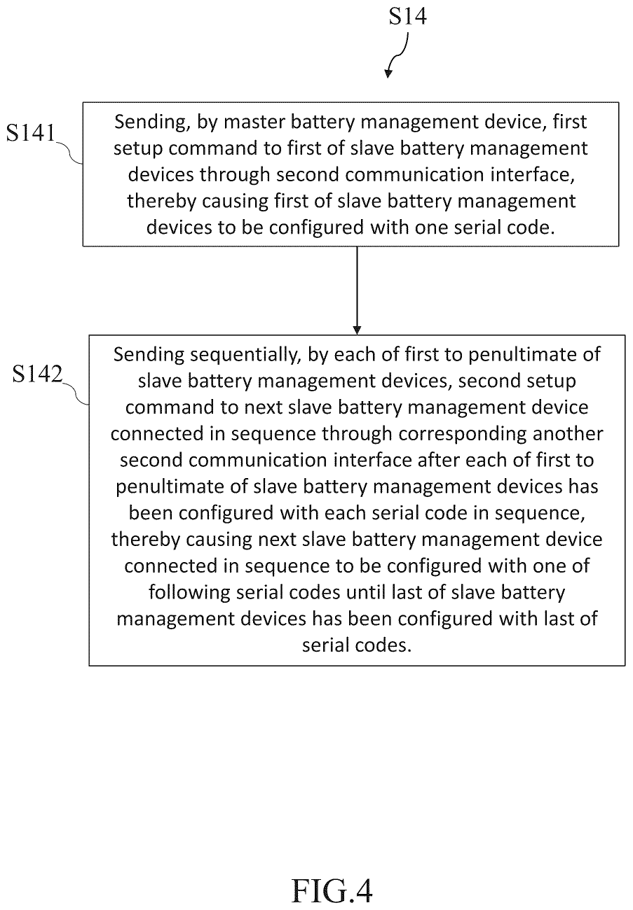

In the current embodiment, the configuration method is performed every time the master battery management device 22 and the slave battery management devices 24 are powered on; that is, the configuration method for the plurality of serial codes would be re-performed to reassign the serial codes when the power is switched off and on again. The configuration method includes the following steps as shown in FIG. 3 and FIG. 4, and the serial codes are illustrated in numbers as an example.

Step S11: sending, by each slave battery management device 24, a notification message to the master battery management device 22 through the first communication interface 30, wherein each notification message includes the identification code of each slave battery management device 24.

In the current embodiment, the notification messages are messages broadcasted on the first communication interface 30. Each slave battery management device 24 sends the notification message, including the identification code of each slave battery management device 24, to the master battery management device 22 through the first communication interface 30. Since each slave battery management device 24 is not assigned any serial code, the content of the notification message does not have a serial code. In an embodiment, if each slave battery management device 24 has stored the serial code assigned during the previous power-on, each slave battery management device 24 clears the serial code previously assigned and then sends the notification message. In an embodiment, if each slave battery management device 24 has stored the serial code assigned during the previous power-on, each slave battery management device 24 does not send the serial code previously assigned in the content of the notification message.

Step S12: receiving, by the master battery management device 22, each notification message sent by each slave battery management device 24 and acquiring, by the master battery management device 22, the identification code of each slave battery management device 24 from each notification message received.

In the current embodiment, the master battery management device 22 receives the plurality of notification messages through the first communication interface 30 and analyzes the plurality of each notification messages to acquire the identification codes therein.

Step S13: counting, by the master battery management device 22, a number of the plurality of identification codes; performing, by the master battery management device 22 and the plurality of slave battery management devices, a configuration step S14 when the master battery management device 22 determines that the number of the plurality of identification codes is equal to a predetermined number of connections.

In the current embodiment, the master battery management device 22 records the predetermined number of connections and a plurality of predetermined serial codes. The predetermined number of connections is a total number of the slave management devices 24 to which the master battery management device 22 is connected by default, i.e., the total number of the battery packs 10 to be connected by default. The predetermined number of connections and the plurality of predetermined serial codes could be recorded in a memory of the master battery management device 22. For example, the predetermined number of connections is twelve, representing that the master battery management device 22 should be connected to twelve slave management devices 24 or battery packs 10 by default. For example, a first of the plurality of predetermined serial codes is 1 (expressed in decimal notation for ease of illustration, but not limited thereto); a second to a last of the predetermined serial codes increment in sequence, i.e., 2 to 12 (expressed in decimal notation for ease of illustration, but not limited thereto); 12 is a maximum value which is an extreme value corresponding to the predetermined number of connections. In the current embodiment, the maximum value is equal to the predetermined number of connections. In practice, the first predetermined serial code is not limited to 1 but could begin with any starting value, such as 0. In this case, the last predetermined serial code would be 11. Although the numerical value is not equal to the predetermined number of connections of twelve, the last predetermined serial code 11 represents the twelfth predetermined serial code, which corresponds to the predetermined number of connections. For example, the predetermined serial code is the letters A to L, in which the last predetermined serial code, L, represents the twelfth predetermined serial code, and L is the extreme value corresponding to the predetermined number of connections. The extreme value of the letters could be determined, for example, by ASCII codes.

The master battery management device 22 counts the number of the plurality of identification codes acquired and determines whether the number of the identification codes acquired is equal to the predetermined number of connections.

If not, i.e., the number of the identification codes acquired is not equal to the predetermined number of connections, representing the number of the slave battery management devices 24 or the battery packs 10 connected to the master battery management device 22 is incorrect, the master battery management device 22 generates a warning message. The warning message could be sent through the first communication interface 30 to warn the control device that the number of the slave management devices 24 or the battery packs 10 is incorrect.

If so, representing the number of the slave battery management devices 24 or the battery packs 10 connected to the master battery management device 22 is correct, then the configuration step S14 is performed. The configuration step S14 includes steps the following steps.

Step S141: sending, by the master battery management device 22, a first setup command once or several times to the first (the slave battery management device 24-1) of the plurality of slave battery management devices 24 through the second communication interface 34, thereby causing the first of the plurality of slave battery management devices 24 to be configured with one of the plurality of serial codes.

In the current embodiment, the first setup command includes the first of the plurality of predetermined serial codes, i.e., the value is 1. After the first slave battery management device 24-1 receives the first setup command, the serial code of the first slave battery management device 24-1 is configured to be the first predetermined serial code specified in the first setup command.

Step S142: sending sequentially, by each of the first (the slave battery management device 24-1) to a penultimate (the slave battery management device 24-11) of the plurality of slave battery management devices 24, a second setup command once or several times to a next slave battery management device 24 connected in sequence through the corresponding another second communication interface 34 after each of the first (the slave battery management device 24-1) to the penultimate (the slave battery management device 24-11) of the plurality of slave battery management devices has been configured with each serial code in sequence, thereby causing the next slave battery management device 24 connected in sequence to be configured with one of the following serial codes until the last (the slave battery management device 24-12) of the plurality of slave battery management devices 24 has been configured with a last of the plurality of serial codes.

In the current embodiment, the serial code that has been configured with the slave battery management device 24 is n. The slave battery management device 24 configured with the serial code specifies a predetermined serial code in a second setup command, and the predetermined serial code increments from the serial code configured, i.e., the predetermined serial code is n+m. In the current embodiment, m=1, but it is not limited thereto; m could be an integral of 1 or more, and it is sufficient that the predetermined serial code in the second setup command matches one corresponding predetermined serial code recorded in the master battery management device 22. After the next slave battery management device 24 receives the second setup command sent by the previous slave battery management device 24, the serial code of the next slave battery management device 24 is configured to be the predetermined serial code specified in the second setup command.

For example, in the order of serial connection, a second slave battery management device 24-2 is connected to the first slave battery management device 24-1 in series, such that the first slave battery management device 24-1 sends the second setup command to the second slave battery management device 24-2 through the second communication interface 34 connected. The second setup command includes a predetermined serial code of 2, and the second slave battery management device 24-2 is configured with the serial code thereof to be 2.

After that, the second slave battery management device 24-2 sends a second setup command to a third slave battery management device 24-3 through the second communication interface 34 connected. The second setup command includes a predetermined serial code of 3, and the third slave battery management device 24-3 is configured with the serial code thereof to be 3.

Subsequently, each slave battery management device from the third slave battery management device 24-3 to the penultimate slave battery management device 24-11 sends a second setup command in the same manner to each next slave battery management device 24 connected in sequence. The penultimate slave battery management device 24-11 sends the second setup command to the last slave battery management device 24-12, and then the last slave battery management device 24-12 is configured with the serial code thereof to be the predetermined serial code of 12 specified in the second setup command. After that, the last slave battery management device 24-12 does not send a second setup command since the third transmission module 246 of the last slave battery management device 24-12 is not connected to the second communication interface 34, but it is not limited thereto. The last slave battery management device 24-12 could send the second setup command through the third transmission module 246, so that each slave battery management device 24 could use the same program code without the need to write a dedicated program code for the last slave battery management device 24-12.

In an embodiment, if each slave battery management device 24 has stored the serial code assigned during the previous power-on and does not clear the serial code previously assigned in step S11, the serial code previously assigned is overwritten with the serial code newly assigned in the configuration step S14. Alternatively, if the serial code previously assigned is the same as the serial code newly assigned, the serial code previously assigned is kept to be the new serial code.

In addition, to determine, by the master battery management device 22, whether the plurality of slave battery management devices 24 have completed the configuration of the serial codes, the master battery management device 22 sends a query message once or several times through the first communication interface 30 after the master battery management device 22 sends the first setup command, wherein the query message is for inquiring each slave battery management device 24 whether the configuration of the serial code has completed. Each slave battery management device 24 sends a response message to the master battery management device 22 through the first communication interface 30 when each slave battery management device 24 configured with each serial code receives the query message, wherein the response message includes the serial code of each slave battery management device 24 configured with each serial code. In an embodiment, in step S141, the master battery management device 22 sends the first setup command several times to the first slave battery management device 24-1 through the second communication interface 32, and the master battery management device 22 stops sending the first setup command when the master battery management device 22 receives any of the response messages. That is, when the master battery management device 22 receives the response message of the first slave battery management device 24-1 or any other slave battery management device 24, the master battery management device 22 could determine that the serial code of one slave battery management device 24 has already been configured, and then the master battery management device 22 stops sending the first setup command. In an embodiment, in step S141, the master battery management device 22 sends the first setup command several times to the first slave battery management device 24-1 through the second communication interface 32. When a number of times that the first setup command is sent reaches a predetermined number of times, the master battery management device 22 stops sending the first setup command.

Since the serial codes of the plurality of slave battery management devices 24 complete the configuration in sequence from the first slave battery management device 24-1 to the last slave battery management device 24-12, the values of the serial codes in the response messages received by the master battery management device 22 are incremented. When the last slave battery management device 24-12 has completed the configuration of the serial code, the value of the serial code in the response message sent by the last slave battery management device 24-12 is the maximum value. In the current embodiment, the maximum value is equal to or corresponds to the predetermined number of connections. When the master battery management device 22 determines that the serial code in any response message received is equal to the maximum value (such as 12) or corresponds to the predetermined number of connections, the master battery management device 22 stops sending the query message and ends the configuration step S14.

In the current embodiment, the master battery management device 22 sends the several query message several times in a predetermined period through the first communication interface 30. When the predetermined period is exceeded and the response message with the serial code equal to the maximum value is not received, representing that the serial code of a certain slave battery management device 24 has failed to be configured, the master battery management device 22 generates a warning message and ends the configuration step S14. The warning message could be sent through the first communication interface 30 to warn the control device that the serial code of the battery pack has failed to be configured. The predetermined period could start to be counted, for example, from the time when sending the first setup command. The predetermined period could be preset to a duration greater than the time required for the plurality of slave battery management devices 24 to be configured with the serial codes. For example, the time required for each slave battery management device 24 to be configured with the serial code is 500 ms, and the predetermined period could be preset to be greater than or equal to six seconds (500 ms×12), e.g., 6 to 12 seconds. The aforementioned predetermined period and the time required for each slave battery management device 24 to be configured with the serial code are merely illustrative and are not limited thereto. In an embodiment, the predetermined period may not be set.

In the current embodiment, the master battery management device 22 adds the plurality of predetermined serial codes recorded to the query message sent. Each slave battery management device 24 configured with each serial code sends each response message to the master battery management device 22 through the first communication interface 30 when the serial code of each slave battery management device 24 matches one of the plurality of predetermined serial codes. When the master battery management device 22 determines that the serial code in any of the response messages received is equal to the maximum value, the master battery management device 22 stops sending the query message and ends the configuration step S14. Alternatively, in the current embodiment, when the serial code in any of the response messages received is equal to or corresponds to the predetermined number of connections, the master battery management device 22 stops sending the query message and ends the configuration step S14.

After the plurality of slave battery management devices 24 have been configured with the plurality of serial codes, each slave battery management device 24 could communicate with the master battery management device 22 through the first communication interface 30, for example, sending the state of each battery pack 10 to the master battery management device 22 through the first communication interface 30.

After that, the master battery management device 22 sends a completion message through the first communication interface 30 to notify the control device that the configuration of the serial codes in the battery management system 20 has completed.

In an embodiment, the master battery management device 22 adds the last predetermined serial code recorded, i.e., the predetermined serial code with the maximum value (which is equal to the predetermined number of connections in the current embodiment), to the query message sent once or several times. After the last slave battery management device 24-12 is configured with the serial code, the last slave battery management device 24-12 sends the response message to the master battery management device 22 through the first communication 30 as the serial code of the last slave battery management device 24-12 matches the predetermined code. After the master battery management device 22 receives the response message, the master battery management device 22 stops sending the query message and ends the configuration step S14. In this way, only the last slave battery management device 24-12 sends the response message, reducing the quantity of the response messages sent through the first communication interface 30. Selectively, the response message could include the serial code of the last slave battery management device 24-12. When the master battery management device 22 receives the response message and then determines that the serial code in the response message received is equal to the maximum value, the master battery management device 22 stops sending the query message.

In an embodiment, the master battery management device 22 sends a query message at least once through the first communication interface 30. For example, the master battery management device 22 could send the query message once after the predetermined period has elapsed since the first setup command is sent. The predetermined period could be preset to be greater than the time required for the plurality of slave battery management devices 24 to be configured with the serial codes. The query message could include all the predetermined serial codes; in this way, after the plurality of slave battery management devices 24 have been configured with the serial codes and then receive the query messages, the plurality of slave battery management devices 24 respond respectively the response messages through the first communication interface 30. Alternatively, the query message could include the last predetermined serial code; in this way, after the last slave battery management device 24-12 has been configured with the serial code and then receives the query message, the last slave battery management device 24 responds the response message through the first communication interface 30.

In an embodiment, in step S141, the master battery management device 22 sends a query message at least once through the first communication interface 30, and the query message includes the first predetermined serial code (such as 1) of the plurality of predetermined serial codes. The first (the slave battery management device 24-1) of the plurality of slave battery management devices 24 sends a response message to the master battery management device 22 through the first communication interface 30 when the serial code of the first slave management device 24-1 matches the first predetermined serial code in the query message, and the response message includes the serial code of the first slave battery management devices 24-1. In this way, when the master battery management device 22 receives the response message sent by the first slave management device 24-1, the master battery management device 22 learns that the first slave management device 24-1 has been configured with the serial code.

Subsequently, in step S142, the master battery management device 22 sends a plurality of another query messages in sequence through the first communication interface 30, and the plurality of another query messages include respectively a second predetermined serial code (such as 2) to a last predetermined serial code (such as 12) of the plurality of predetermined serial codes. Each slave battery management device 24 configured with each serial code sends an another response message to the master battery management device 22 through the first communication interface 30 when the serial code of each slave battery management device 24 matches the predetermined code in each another response message, and the another response message includes the serial code of each slave battery management device 24 configured with each serial code. In this way, after each slave battery management device 24 from the second slave battery management device 24-2 to the last slave battery management device 24-12 has been configured with the serial code, the master battery management device 22 receives sequentially the another response messages sent by the slave battery management devices 24 configured with the serial codes and then learns that each slave management device 24 has been configured with the serial code. When the master battery management device 22 determines that the serial code in the another response message received is equal to the last predetermined serial code, representing the serial code of the last of the plurality of slave battery management devices 24 has been configured, the master battery management device 22 ends the configuration step S14.

In the foregoing, the values of the first predetermined serial code to the last predetermined serial code recorded by the master battery management device 22 are incremented as an example, but it is not limited thereto. In an embodiment, the values of the serial codes could be decremented. In this case, the value of the first predetermined serial code is the maximum value (such as 12) and the last predetermined serial code is the minimum value (such as 1), in which the minimum value is an extreme value corresponding to the predetermined number of connections. In step S141, the first setup command includes the first predetermined serial code (such as 12) of the plurality of predetermined serial codes. In step S142, the predetermined serial code specified in the second setup command by the slave battery management device 24 configured with the serial code decrements from the serial code n configured, i.e., the predetermined serial code specified in the second setup command is n-m. Taking m=1 as an example, m could be an integral of 1 or more. When the master battery management device 22 determines that the serial code in the response message received is the minimum value (i.e., the extreme value corresponding to the predetermined number of connections), representing the serial code of the last of the plurality of slave battery management devices 24 has been configured, the master battery management device 22 ends the configuration step S14.

With the aforementioned configuration method for the plurality of serial codes of the battery management system 20 according to the present invention, the serial codes could be assigned automatically to the slave battery management devices 24 of the battery packs 10 in the sequence of connections, effectively improving the problem that the user could easily make mistakes in setting the serial codes through the switch. Even replacing one or more battery packs 10 or exchanging the battery packs 10, the serial codes could be reassigned to the slave battery management devices 24 after the second communication interface 32 and the second communication interfaces 34 are connected to the corresponding battery packs 10 and the power is on again, thereby eliminating the need for the user to reset the serial codes through the switch.

It is worth mentioning that the serial codes could be configured only when the master battery management device 22 determines that the number of the slave battery management devices 24 (i.e., the number of the battery packs 10) matches the predetermined number of connections, avoiding configuring the serial codes when the number of the battery packs 10 does not match, which could result in incorrect voltage or current supplied by the power storage system.

It must be pointed out that the embodiments described above are only some preferred embodiments of the present invention. All equivalent structures which employ the concepts disclosed in this specification and the appended claims should fall within the scope of the present invention.

What is claimed is:

1. A configuration method for a plurality of serial codes of a battery management system, wherein the battery management system includes a master battery management device and a plurality of slave battery management devices; the master battery management device is connected to the plurality of slave battery management devices through a first communication interface, and a first to a last of the plurality of slave battery management devices are connected in sequence; wherein the first of the plurality of slave battery management devices is connected to the master battery management device through a second communication interface, and each of the two slave battery management devices connected to each other is connected through an another second communication interface;
the configuration method comprising steps of:
A. sending, by each slave battery management device, a notification message to the master battery management device through the first communication interface, wherein each notification message includes an identification code of each slave battery management device and the plurality of identification codes of the plurality of the slave management devices are different from each other;
B. receiving, by the master battery management device, each notification message sent by each slave battery management device and acquiring, by the master battery management device, the identification code of each slave battery management device from each notification message received;
C. counting, by the master battery management device, a number of the plurality of identification codes; performing, by the master battery management device and the plurality of slave battery management devices, a configuration step when the master battery management device determines that the number of the plurality of identification codes is equal to a predetermined number of connections;
wherein the configuration step includes:
D1. sending, by the master battery management device, a first setup command to the first of the plurality of slave battery management devices through the second communication interface, thereby causing the first of the plurality of slave battery management devices to be configured with one of the plurality of serial codes;
D2. sending sequentially, by each of the first to a penultimate of the plurality of slave battery management devices, a second setup command to a next slave battery management device connected in sequence through the corresponding another second communication interface after each of the first to the penultimate of the plurality of slave battery management devices has been configured with each serial code in sequence, thereby causing the next slave battery management device connected in sequence to be configured with one of the following serial codes until the last of the plurality of slave battery management devices has been configured with a last of the plurality of serial codes.

2. The configuration method as claimed in claim 1, wherein the configuration step includes:
sending, by the master battery management device, a query message at least once through the first communication interface;
receiving, by each slave battery management device configured with one of the plurality of serial codes, the query message respectively and sending, by each slave battery management device configured with one of the plurality of serial codes, a response message respectively to the master battery management device through the first communication interface when each slave battery management device configured with one of the plurality of serial codes receives the query message, wherein each response message includes the serial code of each slave battery management device configured with one of the plurality of serial codes.

3. The configuration method as claimed in claim 2, wherein the query message includes a plurality of predetermined serial codes; each slave battery management device configured with each serial code sends each response message to the master battery management device through the first communication interface when the serial code of each slave battery management device matches one of the plurality of predetermined serial codes.

4. The configuration method as claimed in claim 3, wherein the master battery management device sends the query message several times through the first communication interface; one of the predetermined serial codes has an extreme value corresponding to the predetermined number of connections; the master battery management device stops sending the query message when the master battery management device determines that the serial code in any of the response messages received is equal to the extreme value.

5. The configuration method as claimed in claim 4, wherein the master battery management device sends the query message several times in a predetermined period through the first communication interface; the master battery management device generates a warning message when the predetermined period is exceeded and the response message with the serial code equal to the extreme value is not received.

6. The configuration method as claimed in claim 2, wherein the master battery management device sends the query message several times through the first communication interface.

7. The configuration method as claimed in claim 6, wherein the master battery management device stops sending the query message when the master battery management device determines that the serial code in any of the response messages received corresponds to the predetermined number of connections.

8. The configuration method as claimed in claim 2, wherein in step D1, the master battery management device sends the first setup command several times to the first of the plurality of slave battery management devices through the second communication interface.

9. The configuration method as claimed in claim 8, wherein the master battery management device stops sending the first setup command when the master battery management device receives any of the response messages.

10. The configuration method as claimed in claim 1, wherein the configuration step includes:
sending, by the master battery management device, a query message at least once through the first communication interface, wherein the query message includes a predetermined serial code corresponding to the predetermined number of connections;
sending, by the last of the plurality of slave management devices, a response message to the master battery management device through the first communication interface when the serial code of the last of the plurality of slave management devices matches the predetermined serial code; stopping, by the master battery management device, sending the query message after the master battery management device receives the response message.

11. The configuration method as claimed in claim 1, wherein the master battery management device records a plurality of predetermined serial codes; in step D1, the first setup command includes a first predetermined serial code of the plurality of predetermined serial codes, and the first of the plurality of slave battery management devices is configured with the serial code as the first predetermined serial code of the first setup command; in step D1, the master battery management device sends a query message at least once through the first communication interface, and the query message includes the first predetermined serial code; the first of the plurality of slave battery management devices sends a response message to the master battery management device through the first communication interface when the serial code of the first of the plurality of slave management devices matches the first predetermined serial code in the query message, and the response message includes the serial code of the first of the plurality of slave battery management devices.

12. The configuration method as claimed in claim 11, wherein in step D2, the master battery management device sends a plurality of another query messages in sequence through the first communication interface, and the plurality of another query messages include respectively a second predetermined serial code to a last predetermined serial code of the plurality of predetermined serial codes; each slave battery management device configured with each serial code sends an another response message to the master battery management device through the first communication interface when the serial code of each slave battery management device matches the predetermined code in each another response message, and the another response message includes the serial code of each slave battery management device configured with each serial code; wherein the master battery management device ends the configuration step when the master battery management device determines that the serial code in the another response message received is equal to the last predetermined serial code of the plurality of predetermined codes.

13. The configuration method as claimed in claim 1, wherein in step C, the master battery management device generates a warning message when the master battery management device determines that the number of the plurality of identification codes is not equal to the predetermined number of connections.
